(19) United States
(12) Patent Application Publication
(10) Pub. No.: US 2017/0285812 A1
(43) Pub. Date: Oct. 5, 2017

(54) ELECTROMAGNETIC TOUCH PANELS AND ELECTROMAGNETIC TOUCH SYSTEMS

(71) Applicant: Shenzhen China Star Optoelectronics Technology Co. Ltd., Shenzhen (CN)

(72) Inventor: Xiangyang XU, Shenzhen (CN)

(73) Assignee: Shenzhen China Star Optoelectronics Technology Co. , Ltd., Shenzhen (CN)

(21) Appl. No.: 15/176,996

(22) Filed: Jun. 8, 2016

(30) Foreign Application Priority Data
Apr. 1, 2016 (CN) 201610202772.2

(51) Int. Cl. G06F 3/046; G06F 3/042; G06F 3/0354; G06F 3/041

(52) U.S. Cl. CPC G06F 3/046; G06F 3/0416; G06F 3/0421; G06F 3/03545; G06F 2203/04108

(57) ABSTRACT

An electromagnetic touch panel includes a total-reflection light guiding plate and a side frame surrounding the total-reflection light guiding plate. The side frame includes a first side frame, a second side frame opposite to the first side frame, a third side frame, and a fourth side frame opposite to the third side frame. The first side frame and the second side frame are respectively configured with a plurality of first infrared (IR) emitters and a plurality of first IR receivers, and the third side frame and the fourth side frame are respectively configured with a plurality of second IR emitters and a plurality of second IR receivers. Polarized directions of IR rays emitted from the first IR emitters and the second IR emitters are different.

### FIELD OF THE INVENTION

The present invention relates to a touch device, and more particularly to an electromagnetic touch panel and an electromagnetic touch system.

### BACKGROUND OF THE INVENTION

Currently, touch devices may include resistive, capacitive, acoustic wave, infrared and optical type touch devices, wherein the infrared touch device may not be interfered by current, voltage and static electricity and is suitable for harsh environmental, and thus has been widely adopted.

With the increasing applications of the touch devices, the touch devices are now adopted not only by small-scale panels, but also by large-scale panels, such as electronic whiteboards or digital signage. As the panels of the touch technologies have to be contacted, it is possible that bacterium may be bred. In addition, with respect to the contacted spots, due to being touched for a long period of time, the transmittance may be greatly reduced or the surface layer of the touch panel may be wrinkled or sparkling. Further, with respect to the large-scale panels, it is still difficult to implement touch functions.

### SUMMARY OF THE INVENTION

According to the present disclosure, an electromagnetic touch panel and an electromagnetic touch system may provide high precision positioning without direct contact.

In one aspect, an electromagnetic touch panel includes: a total-reflection light guiding plate and a side frame surrounding the total-reflection light guiding plate, the side frame includes a first side frame, a second side frame opposite to the first side frame, a third side frame, and a fourth side frame opposite to the third side frame, the first side frame and the second side frame are respectively configured with a plurality of first infrared (IR) emitters and a plurality of first IR receivers, the third side frame and the fourth side frame are respectively configured with a plurality of second IR emitters and a plurality of second IR receivers, polarized directions of IR rays emitted from the first IR emitters and the second IR emitters are different, after being reflected by the total-reflection light guiding plate a plurality of times, the IR rays emitted from the first IR emitters and the second IR emitters are received by the first IR receivers and the second IR receivers.

Wherein internal sides of the first side frame and the second side frame are configured with a first polarizer and a second polarizer such that polarized directions of the IR rays emitted from the first IR emitter and the second IR emitter are perpendicular to each other

Wherein frequencies of the IR rays emitted from the first IR emitter and the second IR emitter are different.

Wherein the IR rays emitted by the first IR emitters on the first side frame are received by the first IR receivers on the second side frame, and orthographic projections of the first IR receiver and the first IR emitter are overlapped, the IR rays emitted by the second IR emitter on the third side frame are received by the second IR receivers on the fourth side frame, and the orthographic projections of the second IR emitter and the second IR receivers are overlapped.

Wherein the first side frame and the second side frame are respectively configured with a plurality of first IR emitters and the first IR receivers, the first IR emitters and the first IR receivers are spaced by an uniform gap, the third side frame and the fourth side frame are respectively configured with a plurality of second IR emitters and the second IR receivers, and the second IR emitters and the second IR receivers are spaced by the uniform gap.

Wherein a number of the first IR emitters and the gap between the first IR emitters on the first side frame are the same with the number of the first IR receivers and the gap between the first IR receivers on the second side frame, and the number of the second IR emitters and the gap between the second IR emitters on the third side frame are the same with the number of the second IR receivers and the gap between the second IR receivers on the fourth side frame.

Wherein the electromagnetic touch panel includes an IR recognition module connected with the first IR receiver and the second IR receiver, a circuit board connected with the IR recognition module, and a control module connected with the circuit board, the IR recognition module is configured to recognize signals received by the first IR receivers and the second IR receivers, and the control module is configured for controlling the signals emitted by the first IR emitter and the second IR emitter by controlling the circuit board.

Wherein the first IR emitter and the second IR emitter are IR LED emitters.

In another aspect, an electromagnetic touch system includes the electromagnetic touch panel and an electromagnetic touch pen, and a polarized state of the IR rays propagated within the total-reflection light guiding plate is changed after the electromagnetic touch pen contacts with the total-reflection light guiding plate.

In view of the above, the IR rays emitted from the IR emitters arranged on adjacent side frames are received by corresponding IR receivers after being reflected by the total-reflection light guiding plate so as to form an IR matrix. As the polarized directions of the IR rays emitted from the IR emitters are different, the IR signals are prevented from being interfered so as to realize high precision positioning. In addition, when the electromagnetic touch pen moves close to the total-reflection light guiding plate, the polarized state of the IR rays propagated within the total-reflection light guiding plate may be changed, and the IR rays are received by the first IR receiver and the second IR receiver. By analyzing the change of the IR signals, the touch locations may be determined so as to conduct precise positioning under a non-contact mode.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a schematic view of the electromagnetic touch panel in accordance with one embodiment.

FIG. 2 is a side view of FIG. 1.

FIG. 3 is a schematic view of the electromagnetic touch system in accordance with one embodiment.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

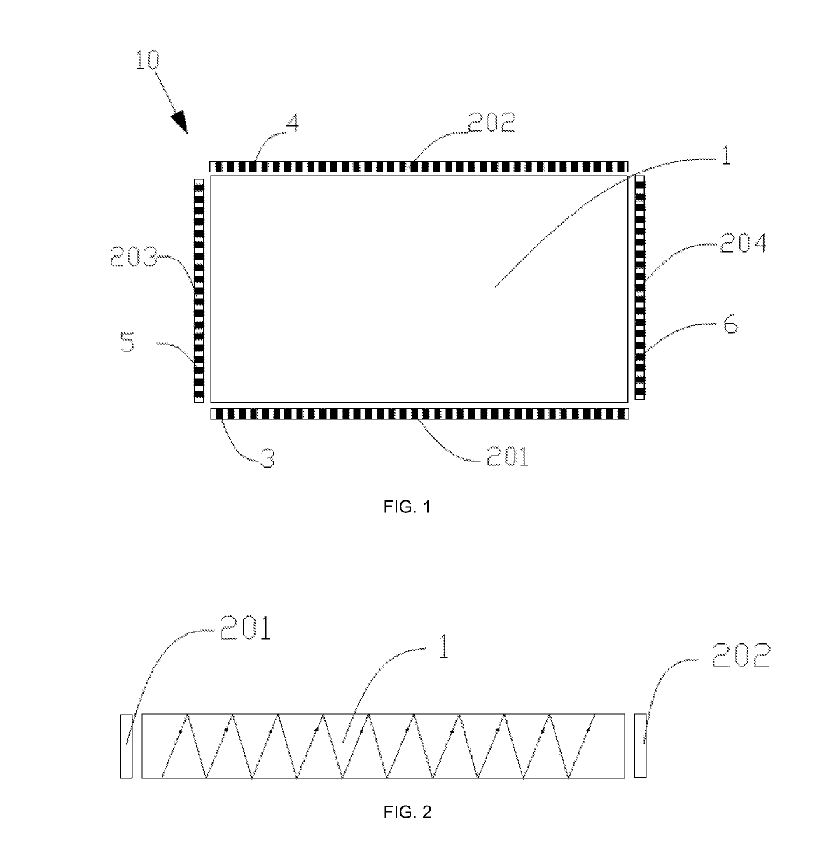

FIG. 1 is a schematic view of the electromagnetic touch panel in accordance with one embodiment. The electromagnetic touch panel 10 includes a total-reflection light guiding plate 1 and a side frame surrounding the total-reflection light guiding plate 1. The side frame includes a first side frame 201, a second side frame 202 opposite to the first side frame 201, a third side frame 203, and a fourth side frame 204 opposite to the third side frame 203. The first side frame 201 and the second side frame 202 are respectively configured with a plurality of first infrared (IR) emitters 3 and a plurality of first IR receivers 4. The third side frame 203 and the fourth side frame 204 are respectively configured with a plurality of second IR emitters 5 and a plurality of second IR receivers 6. The first IR emitter 3 and the second IR emitter 5 are IR LED emitters to ensure the intensity of the IR rays. The first side frame 201 is adjacent to the third side frame 203. In addition, internal sides of the first side frame 201 and the second side frame 202 are configured with a first polarizer (not shown) and a second polarizer (not shown) such that polarized directions of the IR rays emitted from the first IR emitter 3 and the second IR emitter 5 are different. After being reflected by the total-reflection light guiding plate 1, the IR rays emitted from the first IR emitter 3 and the second IR emitter 5 are received by the first IR receiver 4 and the second IR receivers 6. Preferably, the polarized directions of the IR rays emitted from the first IR emitter 3 and the second IR emitter 5 are perpendicular to each other, and the frequencies of the IR rays are different so as to avoid the interference between the IR rays received by the first IR receiver 4 and the second IR receivers 6, which ensures the high precision positioning of the electromagnetic touch panel. Further, wavelengths of the IR rays emitted from the first IR emitter 3 and the second IR emitter 5 are greater than that of visible light, such as blue, green, and red light beams emitted by the pixels of a display panel. Thus, the visible light is also prevented from being interfered. The first IR emitters 3 on the first side frame 201 respectively corresponds to the first IR receivers 4 on the second side frame 202 one by one. The second IR emitters 5 on the third side frame 203 respectively corresponds to the second IR receivers 6 on the fourth side frame 204 one by one. That is, the IR rays emitted by the first IR emitters 3 on the first side frame 201 are received by the first IR receivers 4 on the second side frame 202, and the orthographic projections of the first IR receiver 4 and the first IR emitter 3 are overlapped. The IR rays emitted by the second IR emitter 5 on the third side frame 203 are received by the second IR receivers 6 on the fourth side frame 204, and the orthographic projections of the second IR emitter 5 and the second IR receivers 6 are overlapped. With such configuration, an IR matrix is formed within the total-reflection light guiding plate 1 to perform touch positioning.

As shown in FIG. 1, the first IR emitters 3 and the first IR receivers 4 on the first side frame 201 and the second side frame 202 are spaced by an uniform gap, and the second IR emitters 5 and the second IR receivers 6 on the third side frame 203 and the fourth side frame 204 are spaced by the uniform gap. The number of the first IR emitters 3 on the first side frame 201 is the same with the number of the first IR receiver 4 on the second side frame 202. The gap of the first IR emitters 3 on the first side frame 201 is also the same with the gap of the first IR receivers 4 on the second side frame 202. The number of the second IR emitters 5 on the third side frame 203 is the same with the number of the second IR receivers 6 on the fourth side frame 204. The gap of the second IR emitter 5 on the third side frame 203 is the same with the gap of the second IR receivers 6 on the fourth side frame 204. The above configuration constitutes a uniform IR matrix.

In an example, the gap between the first IR emitters 3 on the first side frame 201 may be different from the gap between the first IR receivers 4 on the second side frame 202. Also, the gap between the second IR emitters 5 on the third side frame 203 may be different from the gap between the second IR receivers 6 on the fourth side frame 204. In addition, the number of the first IR emitter 3 and the gap between the first IR emitters 3 on the first side frame 201 may be different from the number of the first IR receivers 4 and the gap between the first IR receivers 4 on the second side frame 202. The number of the second IR emitters 5 and the gap between the second IR emitters 5 on the third side frame 203 may be different from the number of the second IR receivers 6 and the gap between the second IR receivers 6 on the fourth side frame 204. In brief, the number of the IR emitters and the gap between the emitters may be configured in accordance with real scenario.

Referring to FIG. 2, as the light guiding plate 1 is a total-reflection light guiding plate, the IR rays emitted from the first IR emitters 3 and the second IR emitters 5 configured on the adjacent first side frame 201 and the third side frame 203 may be received by the first IR receivers 4 and the second IR receivers 6 after being reflected a plurality of times. The IR rays emitted from the first IR emitter 3 and the second IR emitter 5 may not be lost such that the intensity of the IR rays is guaranteed, which enhances the precision of positioning.

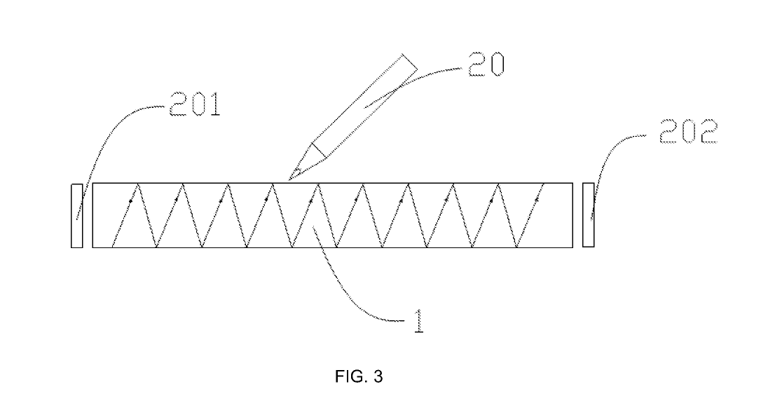

FIG. 3 is a schematic view of the electromagnetic touch system in accordance with one embodiment. The electromagnetic touch system includes the electromagnetic touch panel 10 and an electromagnetic touch pen 20. One end of the electromagnetic touch panel 10 emits electromagnetic signals. When the electromagnetic touch pen 20 indirectly contacts with the total-reflection light guiding plate 1 of the electromagnetic touch panel 10, that is, when the electromagnetic touch pen 20 moves close to the total-reflection light guiding plate 1 of the electromagnetic touch panel 10, the polarized state of the IR rays propagated within the total-reflection light guiding plate 1 may be changed. The IR rays with changed polarized state are received by the first IR receiver 4 and the second IR receivers 6. As the intensity of the polarized rays received by the IR receiver is weakened, the touch positioning may be realized.

In view of the above, the touch positions may be obtained by analyzing the IR signals received by the IR receivers so as to conduct precisely positioning in a non-contact mode. This prevents the touch panel from being pullulated or scraped so as to extend the life cycle of the panel.

It is to be noted that the “indirectly contact” between the electromagnetic touch pen 20 and the total-reflection light guiding plate 1 of the electromagnetic touch panel 10 relates to the impact on the IR rays propagated within the total-reflection light guiding plate 1 when the electromagnetic radiation portion of the electromagnetic touch pen 20 moves close to the total-reflection light guiding plate 1 until a certain distance.

In addition, the electromagnetic touch panel 10 also includes an IR recognition module connected with the first IR receiver 4 and the second IR receiver 6, a circuit board connected with the IR recognition module, and a control module connected with the circuit board. The IR recognition module is configured to recognize the signals received by the first IR receivers 4 and the second IR receivers 6 to obtain a touch position of the electromagnetic touch pen 20. The control module is configured for controlling the signals emitted by the first IR emitter 3 and the second IR emitter 5 by controlling the circuit board. The circuit board and the IR recognition module are arranged on the side frame 2 such that the structure of the electromagnetic touch panel 10 may be more compact. Although the IR recognition module, the circuit board, and the control module are not shown, but the configurations may be similar or the same with conventional ones, and thus are omitted hereinafter.

Above are embodiments of the present invention, which does not limit the scope of the present invention. Any modifications, equivalent replacements or improvements within the spirit and principles of the embodiment described above should be covered by the protected scope of the invention.

What is claimed is:

1. An electromagnetic touch panel, comprising:
a total-reflection light guiding plate and a side frame surrounding the total-reflection light guiding plate, the side frame comprises a first side frame, a second side frame opposite to the first side frame, a third side frame, and a fourth side frame opposite to the third side frame, the first side frame and the second side frame are respectively configured with a plurality of first infrared (IR) emitters and a plurality of first IR receivers, the third side frame and the fourth side frame are respectively configured with a plurality of second IR emitters and a plurality of second IR receivers, polarized directions of IR rays emitted from the first IR emitters and the second IR emitters are different, after being reflected by the total-reflection light guiding plate a plurality of times, the IR rays emitted from the first IR emitters and the second IR emitters are received by the first IR receivers and the second IR receivers.

2. The electromagnetic touch panel as claimed in claim 1, wherein internal sides of the first side frame and the third side frame are configured with a first polarizer and a second polarizer such that polarized directions of the IR rays emitted from the first IR emitter and the second IR emitter are perpendicular to each other

3. The electromagnetic touch panel as claimed in claim 2, wherein frequencies of the IR rays emitted from the first IR emitter and the second IR emitter are different.

4. The electromagnetic touch panel claimed in claim 3, wherein the IR rays emitted by the first IR emitters on the first side frame are received by the first IR receivers on the second side frame, and orthographic projections of the first IR receiver and the first IR emitter are overlapped, the IR rays emitted by the second IR emitter on the third side frame are received by the second IR receivers on the fourth side frame, and the orthographic projections of the second IR emitter and the second IR receivers are overlapped.

5. The electromagnetic touch panel as claimed in claim 4, wherein the first side frame and the second side frame are respectively configured with a plurality of first IR emitters and the first IR receivers, the first IR emitters and the first IR receivers are spaced by an uniform gap, the third side frame and the fourth side frame are respectively configured with a plurality of second IR emitters and the second IR receivers, and the second IR emitters and the second IR receivers are spaced by the uniform gap.

6. The electromagnetic touch panel as claimed in claim 5, wherein a number of the first IR emitters and the gap between the first IR emitters on the first side frame are the same with the number of the first IR receivers and the gap between the first IR receivers on the second side frame, and the number of the second IR emitters and the gap between the second IR emitters on the third side frame are the same with the number of the second IR receivers and the gap between the second IR receivers on the fourth side frame.

7. The electromagnetic touch panel as claimed in claim 1, wherein the electromagnetic touch panel comprises an IR recognition module connected with the first IR receiver and the second IR receiver, a circuit board connected with the IR recognition module, and a control module connected with the circuit board, the IR recognition module is configured to recognize signals received by the first IR receivers and the second IR receivers, and the control module is configured for controlling the signals emitted by the first IR emitter and the second IR emitter by controlling the circuit board.

8. The electromagnetic touch panel as claimed in claim 7, wherein the first IR emitter and the second IR emitter are IR LED emitters.

9. An electromagnetic touch system comprises the electromagnetic touch panel as claimed in claim 1 and an electromagnetic touch pen, a polarized state of the IR rays propagated within the total-reflection light guiding plate is changed after the electromagnetic touch pen contacts with the total-reflection light guiding plate.
